(19) United States
(12) Patent Application Publication
(10) Pub. No.: US 2026/0287907 A1
(43) Pub. Date: Sep. 24, 2026

(54) SMART GLASSES WITH DISPLAY

(71) Applicant: SOLOS TECHOLOGY LIMITED, Hong Kong (CN)

(72) Inventors: Chin Chiang John Fan, Hong Kong (CN); Yoichi Iba, Hong Kong (CN); Wai Kuen Kenny Cheung, Hong Kong (CN)

(21) Appl. No.: 19/537,555

(22) Filed: Feb. 12, 2026

(30) Foreign Application Priority Data
Mar. 24, 2025 (CN) 202510351999.2

(51) Int. Cl. G02B 27/01; G02C 9/00

(52) U.S. Cl. CPC G02B 27/0176; G02B 27/0179; G02C 9/00; G02B 2027/0178; G02B 2027/0187

(57) ABSTRACT

Smart glasses with display and control method thereof are provided, which include: a frame, lenses and a temple. A nose pad is provided on rims of the frame. The smart glasses further include: a first optical device, disposed on an inner side of the smart glasses, for emitting a light beam carrying image information; and a second optical device, located on the nose pad or the rim nearby the nose pad location and directly facing a light-emitting surface of the first optical device, for guiding the light beam toward the eye of the user. The ambient light on both sides of lenses of the smart glasses can freely and bidirectionally transmit, and there are no visual blind spots when viewing from either side to the other, thereby enhancing the user experience. The display method for the smart glasses has no requirements on the type of lenses, thus reducing the costs.

### CROSS REFERENCE TO RELATED APPLICATIONS

The present application claims priority of Chinese Patent Application No. 202510351999.2, filed on Mar. 24, 2025, the entire contents of which are hereby incorporated by reference.

### BACKGROUND

### 1. Technical Field

The present disclosure generally relates to the field of smart wearable products, and particularly to smart glasses with display and a control method for the smart glasses.

### 2. Description of Related Art

Smart wearable devices are a general term for wearable devices obtained by intelligently designing and developing daily wearable items, such as watches, wristbands, glasses, clothing, and the like. As a representative type of the smart wearable devices, the smart glasses are being applied to various aspects of people's life, work and entertainment.

Smart glasses typically include AR glasses, VR glasses, AI glasses, and similar devices. They integrate artificial intelligence (AI) technology and offer functions such as voice interaction, translation, photography, navigation, and display. These glasses can translate languages in real time, capture memorable moments, and provide a convenient operating experience. For instance, some AI smart glasses allow users to easily take photos and record videos while skiing, cycling, or driving, and they also support music playback and navigation activation through voice control.

Additionally, some AR and AI smart glasses feature a near-eye display function that can project information—such as images, text, and videos—directly into the user's field of vision, enabling capabilities like navigation, message notifications, and schedule reminders. Consequently, these devices enhance the efficiency of information acquisition, the convenience of interaction, and the immersive experience. Furthermore, these smart glasses include privacy protection features that prevent others from viewing the displayed content, making them suitable for use in public places.

The glasses with near-eye display should preferably meet the following requirements: 1. from the perspective of aesthetic design, the eyepiece optical devices for near-eye display should not appear obtrusive to third-party observers; 2. from the perspective of the convenience of daily wear, when the user observes the external world through the smart glasses, the eyepiece optical devices should minimize obstruction to the external field of view; 3. from the perspective of viewing the displayed images, the images presented by the eyepiece optical devices should be projected at a position that is easy for the user to view; and 4. the smaller the modification to the lenses, the better, and the glasses should be as compatible with various types of lenses as possible.

FIG. 1A illustrates a structure principle of a type of existing smart glasses. As shown in FIG. 1A, a light guide plate is disposed in the area A of lens 11, an optical engine 12 is disposed on the frame or temple, and the light guide plate is provided with several beam splitter films 111. When the image source light beam emitted by the optical engine 12 enters the light guide plate, it is confined to transmit inside the light guide plate due to the total internal reflection of the inner wall of the light guide plate, and at each beam splitter film 111, a portion of the image source light is reflected to the eye of the wearer, thus enabling the wearer to view the image displayed by the optical engine 12.

However, the near-eye display manner shown in FIG. 1A has drawbacks. The wearer can see both the ambient light and image source light simultaneously. However, since no light passes through the aforementioned area A from the wearer's side towards to the opposite side of the wearer, when a person stands opposite the wearer and looks at the wearer, there is a viewing blind zone on the lens corresponding to the area A, which makes it difficult for the person to see the wearer's eye area, as shown in FIG. 1B. This will result in a poor experience for the interaction and communication between both parties. The main reason for this situation is that the light guide plate on the image source light path blocks the transmission of the ambient light from the wearer's side to the opposite side. Moreover, such glasses require the use of specialized optical waveguide lenses, and thus fail to meet the aforementioned requirement 4.

FIG. 2 illustrates a principle of near-eye display based on projection for another type of smart glasses. As shown in FIG. 2, a lens 21 has a reflective area 23, and the image source light beam emitted by an optical engine 22 is projected onto the reflective area 23 and is further guided to the human eye by the reflective area 23. Since the reflective area 23 on the lens 21 blocks a portion of ambient light, the near-eye display technology shown in FIG. 2 fails to meet the aforementioned requirement 2. Moreover, since it requires the dedicated provision of the reflective area 23 on the lens 21, this the near-eye display technology also fails to meet the aforementioned requirement 4.

There is another type of smart glasses in which the optical engine is hidden and arranged on the inner side of the upper rim of the frame, and the light beam emitted by the optical engine is directly projected into the human eye. Although this method can meet the aforementioned requirements 1 and 2, it requires the wearer to look upward to view the displayed content, and long-term upward gazing by the wearer will cause visual fatigue and make the wearer prone to dizziness, thus the method fails to meet the aforementioned requirement 3. Moreover, there are few scenarios in daily life that require looking upward, hence, to a third party, it seems strange that the wearer's gaze often drifts upward. Furthermore, this method requires integrating a small display device into the ocular optical devices, which brings another problem: the display device requires power and image signals, and the image signals must be transmitted through the interior of the frame. This causes the upper part of the frame to become thicker, which is undesirable from the perspective of aesthetic design. This problem becomes even more pronounced, especially for high-resolution display devices that require more wires.

### SUMMARY

The present disclosure aims to provide smart glasses with display and a control method for the smart glasses, where the optical elements of the smart glasses used to realize the display function do not affect the bidirectional transmission of ambient light on both sides of the lenses, thereby avoiding visual blind spots, improving user experience, and further enabling compatibility with any traditional lenses.

In one embodiment, smart glasses with display are provided. The smart glasses include a frame, lenses and a temple, and a nose pad is provided on rims of the frame. The smart glasses further include:

a first optical device, provided on an inner side of the smart glasses, and configured to emit a light beam carrying image information; and

a second optical device, located on the nose pad or a rim nearby a nose pad location, wherein the second optical device directly faces a light-emitting surface of the first optical device, and is configured to guide the light beam toward an eye of a user.

In one embodiment, a control method for the smart glasses with display is provided. The smart glasses further include a sensor and a processor. The control method includes: obtaining, through the sensor of the smart glasses, images of the at least one eye of the user; analyzing, through the processor of the smart glasses, the images of the at least one eye of the user, and determining whether an eye state of the user meets a preset light emission trigger condition; and controlling, through the processor of the smart glasses, the first optical device of the smart glasses to emit the light beam in response to the eye state of the user meeting the preset light emission trigger condition.

In the smart glasses with display provided in the present disclosure, the first optical device is disposed on the inner side of the smart glasses, the second optical device is disposed on the nose pad or the rim nearby the nose pad location, and the light beam carrying image information emitted by the first optical device is guided and directed toward the wearer's eye through the second optical device, thereby enabling the wearer to view the displayed image. Since neither the first optical device nor the second optical device is disposed on the lenses, the ambient light on both sides of the lenses can transmit freely in both directions. That is, the ambient light can not only transmit from the inner side of the lenses (the inner side refers to the side where the wearer's eye is located) through the lenses to the outer side (the outer side refers to the side opposite to the inner side), but also do so from the outer side of the lenses through the lenses to the inner side. No visual blind spots will appear when observed from either side to the other. Thus, the user's experience can be improved. Moreover, the display method of the smart glasses has no requirements on the type of lenses and requires no specialized waveguide lenses or other custom-made lenses. Therefore, it can reduce costs and can be applied to any lenses, such as sunglass lenses, photochromic lenses, blue-light-blocking lenses, and prescription lenses.

### BRIEF DESCRIPTION OF THE DRAWINGS

FIG. 1A is an optical schematic diagram of smart glasses with near-eye display provided by the prior art; and FIG. 1B is an effect diagram of other people viewing eyes of a wearer from the opposite side of the wearer after wearing the smart glasses shown in FIG. 1A.

FIG. 2 is an optical schematic diagram of smart glasses employing a projection-based near-eye display, as provided in the prior art.

FIG. 3 is an external structural diagram of smart glasses according to an embodiment of the present disclosure.

FIG. 4 is an enlarged schematic diagram of a first optical device in FIG. 3.

FIG. 5 is a structural diagram of the smart glasses provided with the first type of a first orientation adjustment device according to an embodiment of the present disclosure.

FIG. 6 is an exploded structural diagram of the first type of the first orientation adjustment device and the first optical device according to an embodiment of the present disclosure.

FIG. 7 is a structural diagram of the second type of the first orientation adjustment device according to an embodiment of the present disclosure.

FIG. 8 is a structural diagram of the smart glasses provided with the first type of a second orientation adjustment device according to an embodiment of the present disclosure.

FIG. 9 is an enlarged schematic diagram of an area A in FIG. 8.

FIG. 10 is a structural diagram of the smart glasses provided with the second type of the second orientation adjustment device according to an embodiment of the present disclosure.

FIG. 11 is an enlarged schematic diagram of an area B in FIG. 10.

FIG. 12 is a structural diagram of the smart glasses provided with the fourth type of the second orientation adjustment device according to an embodiment of the present disclosure.

FIG. 13 is an enlarged schematic diagram of an area C in FIG. 12.

FIG. 14A is a first structural diagram of the second optical device according to an embodiment of the present disclosure.

FIG. 14B is an equivalent optical path diagram of a light beam passing through the second optical device shown in FIG. 14A.

FIG. 15 is a second structural diagram of the second optical device according to an embodiment of the present disclosure.

FIG. 16 is a first optical structural schematic diagram of the smart glasses according to an embodiment of the present disclosure.

FIG. 17 is a second optical structural schematic diagram of the smart glasses according to an embodiment of the present disclosure.

FIG. 18 is a third optical structural schematic diagram of the smart glasses according to an embodiment of the present disclosure.

FIGS. 19 and 19B are two structural diagrams of prisms according to an embodiment of the present disclosure.

FIG. 20 is a schematic diagram of partitioned design on an inner side of the frame of the smart glasses according to an embodiment of the present disclosure.

FIG. 21 is a schematic diagram of viewing angle when the second optical device is placed in an area T in FIG. 20.

FIGS. 22A and 22B are schematic diagrams of line-of-sight occlusion when the second optical device is located in areas T and N in FIG. 20.

FIG. 23 is a schematic diagram of fields of view of left and right eyes of people in daily life.

FIG. 24 is a schematic diagram of the positions of the first optical device and the second optical device.

FIG. 25 is a schematic diagram that further adds exemplary values based on FIG. 24.

FIG. 26 is an appearance diagram when viewing FIG. 25 from a third party's perspective.

FIG. 27 is a schematic diagram of electrical modules of the smart glasses according to an embodiment of the present disclosure.

FIG. 28 is a flow chart of a control method for the smart glasses shown in FIG. 3.

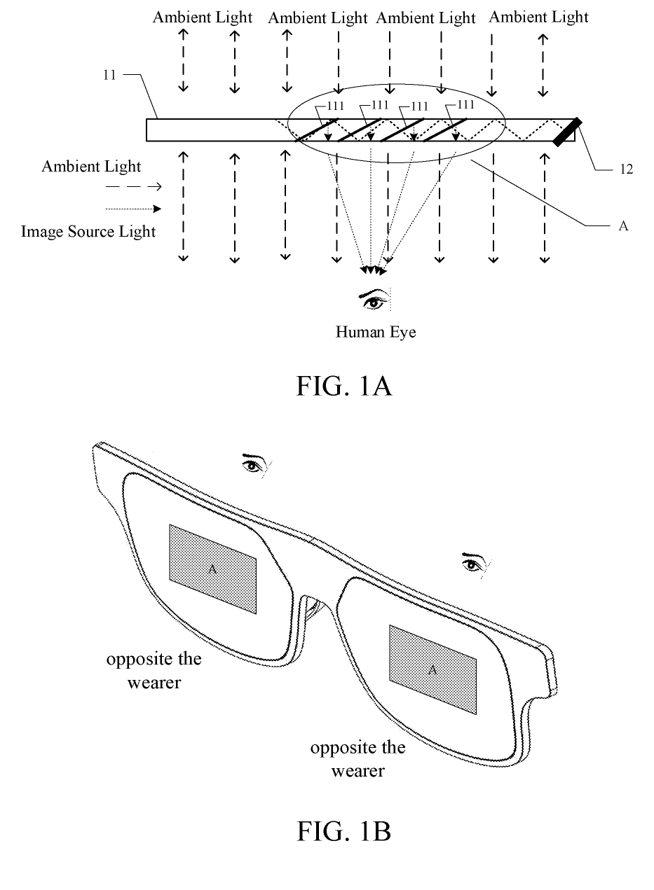

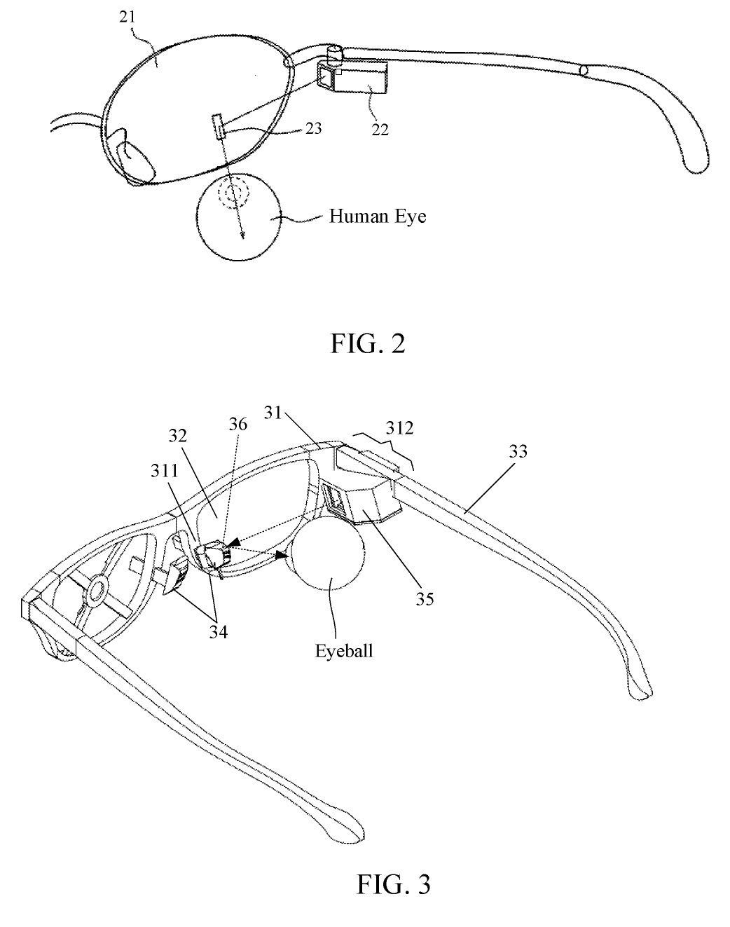

### DETAILED DESCRIPTION

In order to make the objects, technical solutions and advantages of the present disclosure clearer, the technical solutions in the present disclosure will be clearly and completely described below with reference to the drawings in the embodiments of the present disclosure. It should be understood that the specific embodiments described herein are merely used to explain the present disclosure and are not used to limit the present disclosure.

The smart glasses provided by the present disclosure have a display function, which can guide image information such as displayed images and videos to at least one of the eyes of the wearer in the form of projection and reflection. The smart glasses may be the AR (Augmented Reality) glasses, VR (Virtual Reality) glasses, or AI glasses, and may have at least one of the functions of voice interaction, translation, photography, navigation and display.

FIG. 3 is an external structural diagram of smart glasses according to an embodiment of the present disclosure. Referring to FIG. 3, the smart glasses include a frame 31, two lenses 32, and two temples 33. The lenses 32 are fixedly mounted in the frame 31, and the lenses 32 may be the sunglass lenses, photochromic lenses, blue-light-blocking lenses, or prescription lenses for myopia, astigmatism, etc. It should be noted that FIG. 3 merely exemplarily illustrates the external appearance of the smart glasses. In specific implementations, additional structural designs may further be added according to the requirements of application scenarios. For example, a helmet structure may be added on the basis of the main body of the glasses, or a headband for connection may be designed at the ends of the two temples. All of these are within the protection scope of the present disclosure.

The frame 31 may be designed as various shapes such as square, oval, round, etc. The rims 311 of the frame 31 near the nose bridge side are provided with nose pads 34, and the smart glasses are supported on the wearer's nose bridge through the nose pads 34.

Some electronic components (such as rechargeable batteries, speakers, microphones, 9-axis sensors, Bluetooth modules, sensors, cameras, touch sensors, memories, processors, etc.) may be built into the temples 33 according to specific needs. In specific implementations, all or part of the aforementioned electronic components may be built into as needed, or other required components may be added. Of course, some of these electronic components may further be built into the frame 31.

The frame 31 and the temples 33 are connected by hinges. Specifically, both sides of the frame 31 bend towards the temples 33 to form end-pieces 312, and the temples 33 are respectively hinged with the end-pieces 312.

The smart glasses further include: a first optical device 35 and a second optical device 36.

The first optical device 35 is provided on an inner side of the smart glasses, and is used to emit a light beam carrying image information. The inner side refers to a side facing the wearer's skin. Specifically, the inner side may be an inner side of the end piece 312 as shown in FIG. 3, or further may be an inner side of one end of the temple 33 near to the frame 31.

The second optical device 36 is located on the nose pad 34, or is located on the rim 311 nearby the location of the nose pad 34. For example, the second optical device 36 is located on the rim 311 nearby the nose pad location, specifically above or below the nose pad 34 at a distance of less than or equal to a preset distance (e.g., 0.5 cm), and is directly facing a light-emitting surface of the first optical device 35, for guiding the light beam toward the wearer's (or user's) eye.

The face shapes of different wearers vary, for example, the relative positional relationships between the ears, nose bridges, and eyes vary from person to person. Therefore, to ensure that the light beam of the first optical device 35 is accurately projected onto the second optical device 36, the smart glasses may further include a first orientation adjustment device 37. The first orientation adjustment device 37 is provided on the temple 33 and connected to the first optical device 35, and is used to adjust the position of the first optical device 35 on the temple 33 and the light-emitting direction of the first optical device 35.

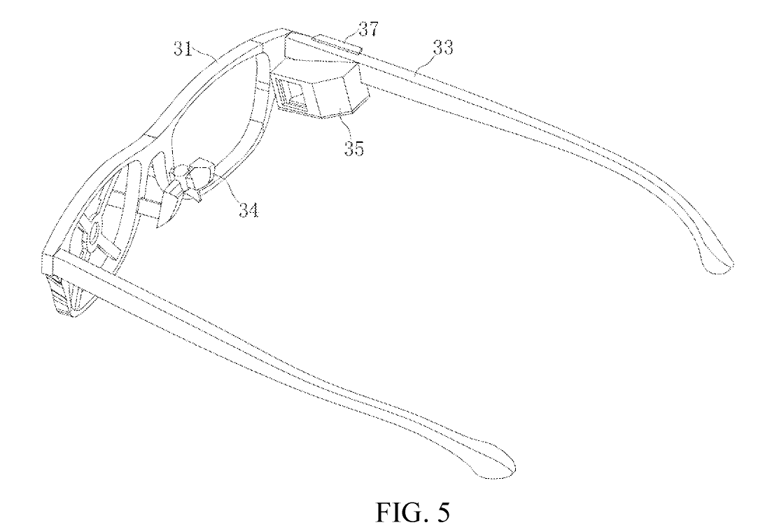

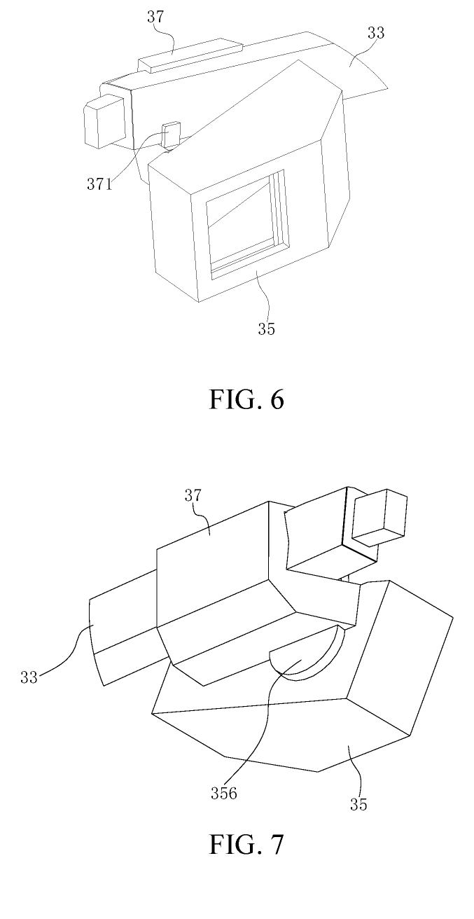

In a preferred embodiment, referring to FIGS. 5 and 6, a sliding slot is provided inside the first orientation adjustment device 37, and the temple 33 is embedded in the sliding slot. The inner side of the first orientation adjustment device 37 is provided with a plug-in part 371, and the inner side of the housing of the first optical device 35 is provided with a slot. The first optical device 35 and the first orientation adjustment device 37 are fixedly connected via plug-in, and are jointly arranged around the outer periphery of the temple 33. The sliding slot can slide forward or backward along the length direction of the temple 33 when the first optical device 35 is pushed forward or backward, so as to achieve the position adjustment of the first optical device 35.

In another preferred embodiment, referring to FIG. 7, a sliding slot is provided inside the first orientation adjustment device 37, and the temple 33 is embedded in the sliding slot. This embodiment can also achieve the position adjustment of the first optical device 35. The difference from the previous embodiment is that, in this embodiment, the inner side of the first orientation adjustment device 37 is not provided with a plug-in part, but is instead provided with a hinge hole. A hinge shaft 356 is fixed on the inner side of the housing of the first optical device 35, and the first optical device 35 and the first orientation adjustment device 37 are hinged to each other by inserting the hinge shaft 356 into the hinge hole. The wearer can control the first optical device 35 to swing up and down relative to the first orientation adjustment device 37 and the temple 33, so as to achieve the dual adjustment of the position and light-emitting direction (the position and the orientation of the optical transmission window 352) of the first optical device 35. Of course, as a modified design of the FIG. 7, the slot may also be designed as a non-slidable structure, and the temple 33 is fixedly embedded in the slot. In this modified design, the first orientation adjustment device 37 does not slide along the length direction of the temple; instead, the adjustment of the light-emitting direction can only be achieved by controlling the first optical device 35 to swing up and down relative to the first orientation adjustment device 37 and the temple 33.

Regarding the specific position of the second optical device 36, as an implementation solution, the second optical device 36 may be located on the rim 311 nearby the location of the nose pad 34, and the second optical device 36 is located below the nose pad 34. Therefore, the risk of the light emitted by the first optical device 36 being interfered with by the wearer's eyelids or eyelashes can be reduced.

The specific mounting manners between the second optical device 36 and the nose pad 34 or the rim 311 may include but are not limited to the following three solutions:

Solution 1: Directly use a surface of the nose pad 34 or a surface of the rim 311 as the reflective surface; that is, the second optical device 36 is integrally formed on the surface of the nose pad 34 or the surface of the rim 311, and the surface faces the light-emitting direction of the first optical device 35.

Solution 2: The second optical device 36 is mounted on the surface of the nose pad 34 or the surface of the rim 311 in a detachable manner, and the surface faces the light-emitting direction of the first optical device 35. The detachable manner may be snap connection, screw connection, or other methods.

Solution 3: The second optical device 36 is fixedly disposed on the surface of the nose pad 34 or the surface of the rim 311, and the surface faces the light-emitting direction of the first optical device 35. Unlike Solution 2, the connection between the second optical device 36 and the nose pad 34 / rim 311 is non-detachable.

Further, the smart glasses of the embodiment may further include a second orientation adjustment device, and the second orientation adjustment device is disposed on the frame 31 or the nose pad 34 and connected to the second optical device 36. The position and orientation of the second optical device 36 can be adjusted by operating the second orientation adjustment device.

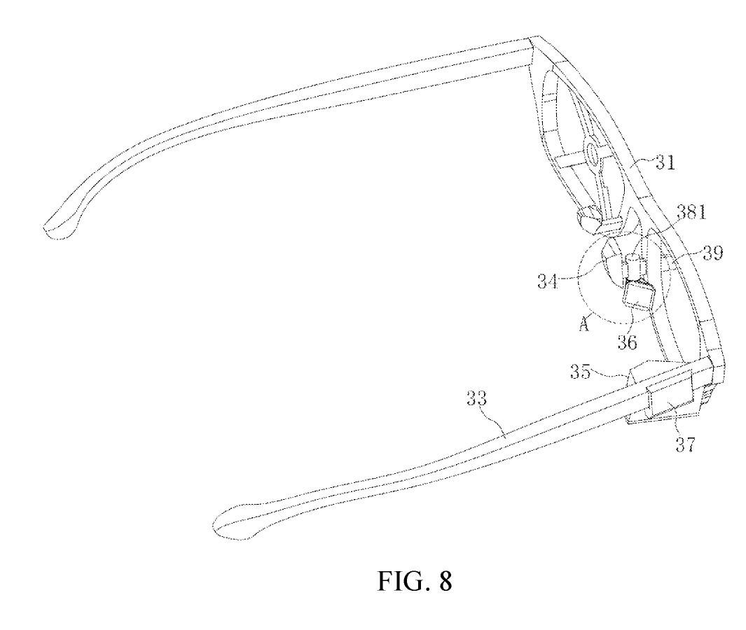

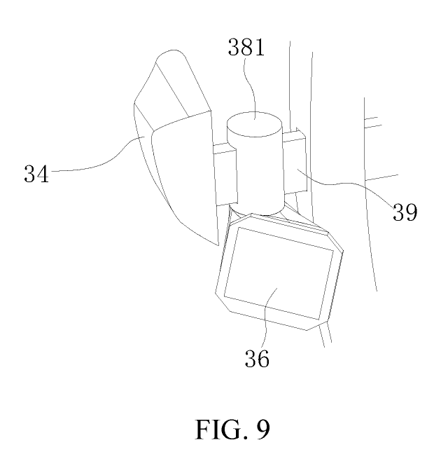

As the first preferred solution, referring to FIGS. 8 and 9, the second orientation adjustment device includes a sliding block 381. The sliding block 381 is cylindrical, and is slidably sleeved over a connecting member 39 used to connect the nose pad 34 and the frame 31. The sliding block 381 is allowed to slide forward or backward relative to the connecting member 39 by pushing the sliding block 381, so as to adjust the forward/rearward position of the second optical device 36 relative to the wearer's face. The second optical device 36 is rotatably connected to the bottom end of the sliding block 381 and can be rotated around the sliding block 381 by twisting the second optical device 36, so as to achieve the adjustment of the orientation of the second optical device 36.

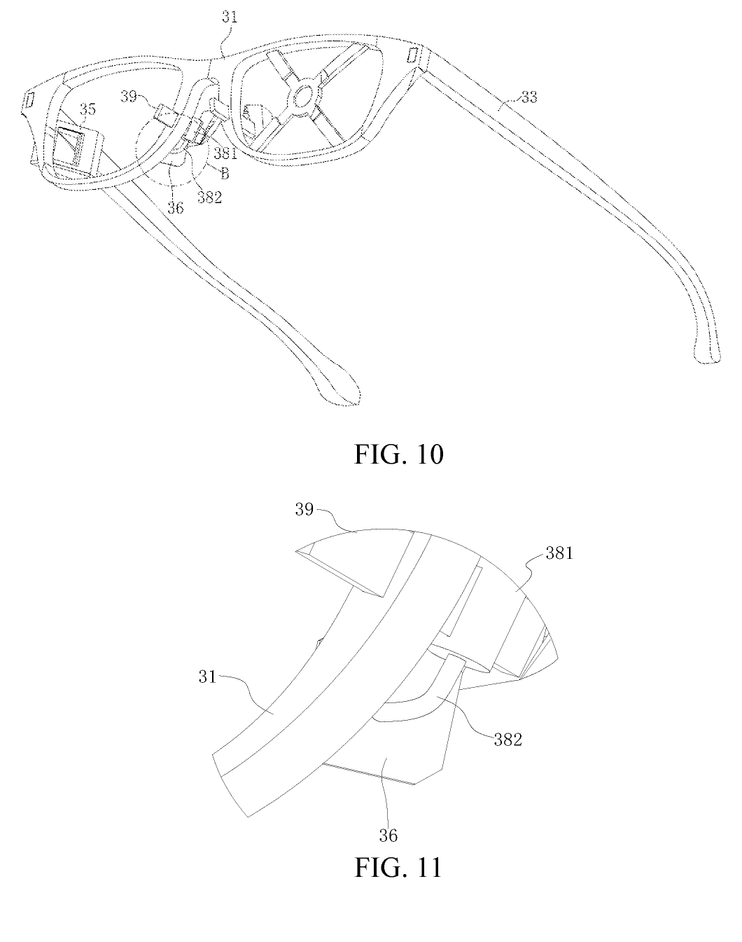

As the second preferred solution, referring to FIGS. 10 and 11, the second orientation adjustment device includes: the sliding block 381 and a flexible arm 382. The sliding block 381 is slidably sleeved over the connecting member 39 used to connect the nose pad 34 and the frame 31. The sliding block 381 is allowed to slide forward or backward relative to the connecting member 39 by pushing the sliding block 381, so as to adjust the forward/rearward position of the second optical device 36 relative to the wearer's face. One end of the flexible arm 382 is fixedly connected to the sliding block 381, and the other end is fixedly connected to the second optical device 36. The flexible arm 382 is highly flexible and can be deformed through manipulation, allowing the second optical device 36 to be positioned in a suitable position and orientation.

As the third preferred solution, the second orientation adjustment device only includes the flexible arm 382. The second optical device 36 or the nose pad 34 with the second optical device 36 attached is directly fixed to the frame 31 via the deformable flexible arm 382 (e.g., a steel wire). When the flexible arm 382 deforms under force, it causes the angle between the second optical device 36 and the wearer's eye to change relative to the first optical device 35. This change allows the second optical device 36 to guide the light beam towards the wearer's eye.

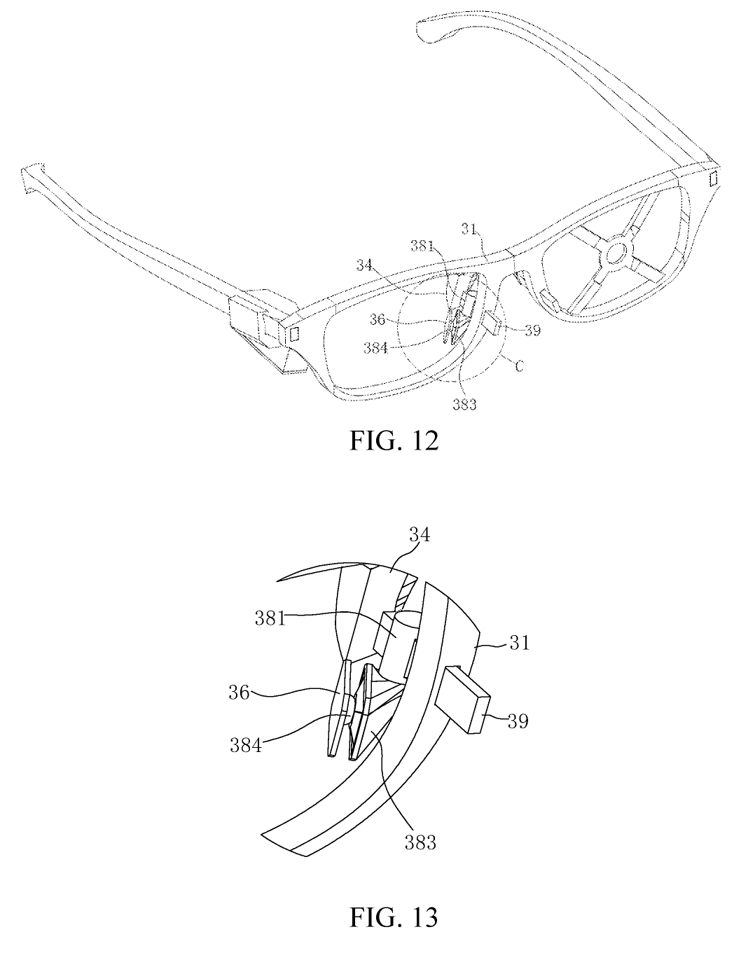

As the fourth preferred solution, referring to FIGS. 12 and 13, the second orientation adjustment device includes a sliding block 381, a hinged mounting seat 383, and a ball joint structure 384. The sliding block 381 is slidably sleeved over the connecting member 39 used to connect the nose pad 34 and the frame 31. The sliding block 381 is allowed to slide forward or backward relative to the connecting member 39 by pushing the sliding block 381, so as to adjust the forward/rearward position of the second optical device 36 relative to the wearer's face. The hinged mounting seat 383 is fixedly connected to the sliding block 381, and the ball joint structure 384 is embedded in a mounting cavity of the hinged mounting seat 383. The second optical device 36 is fixedly connected to the part of the ball joint structure 384 that is exposed outside the mounting cavity. The second optical device 36 can be swung to any desired angle within a large angular range by operating the second optical device 36, thereby achieving adjustment of the orientation of the second optical device 36.

Both the first orientation adjustment device 37 and the second orientation adjustment device are used to enable the second optical device 36 to accurately guide the light beam emitted by the first optical device 35 to the wearer's eye. Since different wearers may have different facial shapes and depths of eye sockets, it can be ensured that the light beam is guided into the eyes of different wearers, by adjusting the position/light-emitting direction of the first orientation adjustment device 37 or the inclination angle of the second orientation adjustment device. Of course, it is also possible to adjust both the first orientation adjustment device 37 and the second orientation adjustment device simultaneously.

As can be seen from the above, the main function of the second optical device 36 is to reflect the light beam, and the structure of the second optical device 36 may include the following two types:

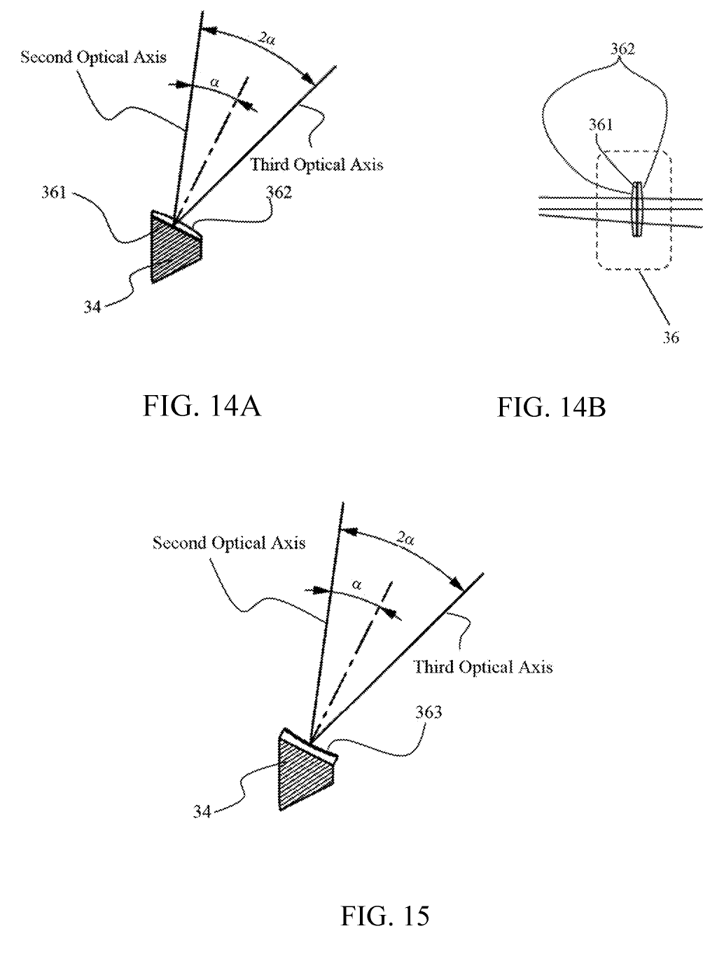

The first type is shown in FIG. 14A, where the second optical device 36 includes a reflective surface 361, and a convex surface 362 is convexly provided on the light-incident side of the reflective surface 361. The light beam passes through the convex surface 362 and is incident on the reflective surface 361, and then is reflected by the reflective surface 361 and passes through the convex surface 362 again to reach the wearer's eye. The normal to the reflective surface 361 has an inclination angle relative to the optical axis of the incident light beam.

The first optical device 35 emits light to the second optical device 36, and the second optical device 36 then projects the light in a direction and at a distance easily visible to the wearer. To project light at the distance easily visible to the wearer, the second optical device 36 must have the positive refractive power. The convex surface 362 exactly has the positive refractive power, just like the convex surface of an ordinary convex lens. During the entire process, the light beam essentially passes through the convex surface 362 twice: first entering through the convex surface 362, and second exiting through the convex surface 362, and its equivalent optical path diagram is shown in FIG. 14B. Therefore, the light beam is affected by the positive refractive power of the convex surface 362 twice, which enables the light beam to be projected at the distance easily visible to the wearer. Additionally, the reflective surface 361 is inclined relative to the optical axis of the incident light beam, which helps to project the light beam in the direction easily visible to the user.

The second type is shown in FIG. 15, where the second optical device 36 includes a concave reflective surface 363, the light beam is reflected by the concave reflective surface 363 to the wearer's eye, and a normal to the concave reflective surface 363 has an inclination angle relative to the optical axis of the incident light beam.

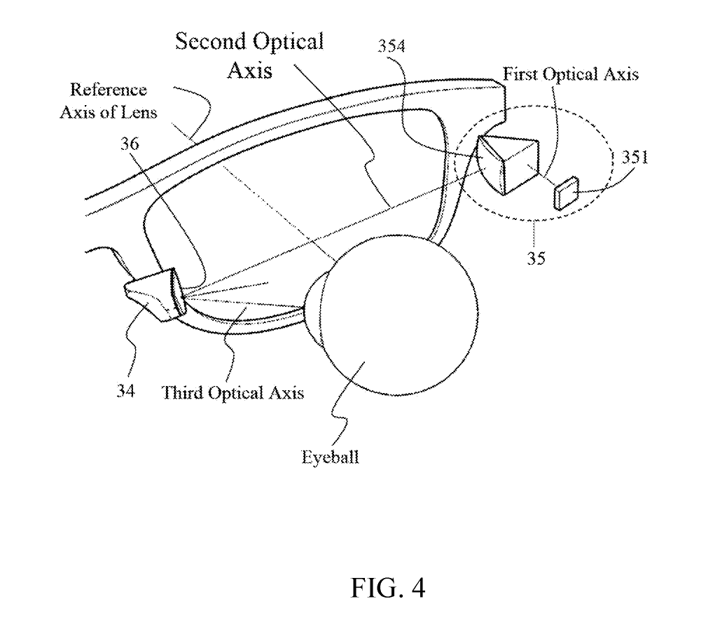

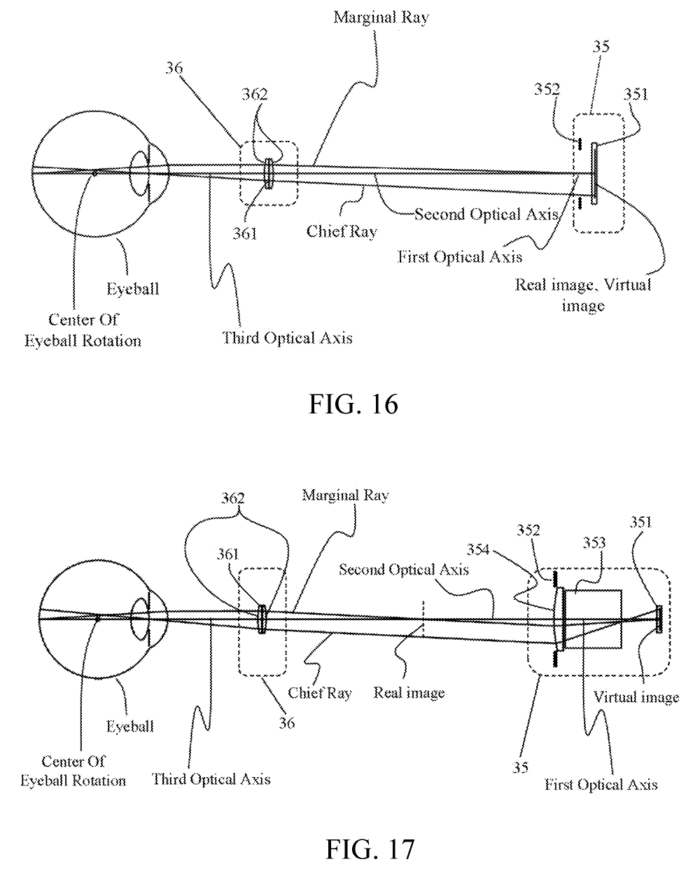

The first optical device 35 may adopt an optical engine, as shown in FIGS. 4 and 16. The optical engine may include an image display element 351 and an optical transmission window 352. The image display element 351 is used to emit a light beam carrying image information, and after exiting from the optical transmission window 352, the light beam is transmitted toward the direction where the second optical device 36 is located. The type of the image display element 351 is not limited, for example, it may adopt Micro-LED (Micro Light-Emitting Diode), Micro-OLED (Micro Organic Light-Emitting Diode), LCoS (Liquid Crystal on Silicon), LCD (Liquid Crystal Display), DMD (Digital Micromirror Device), DLP (Digital Light Processing), or LBS (Laser Beam Scanning), etc. The optical transmission window 352 acts to block any light that does not propagate toward the direction where the second optical device 36 is located, thereby preventing image light from leaking to the outside.

The aforementioned "image information" carried in the light beam may be the images or videos pre-stored in the smart glasses, or the images or videos received from external devices. For example, when the wearer's mobile phone receives an image or video, the mobile phone transmits the image or video to the smart glasses through a Bluetooth channel established between the mobile phone and the smart glasses, and the smart glasses project and display the image or video through the first optical device 35 for the wearer to view, so that the wearer does not need to specially check the mobile phone.

As a preferred solution, the center position of the optical transmission window 352 is lower than the upper surface of the temple 33, so as to reduce the risk of light escaping from the optical transmission window 352 and being blocked by the upper eyelid when moving toward the second optical device 36.

Optionally, as shown in FIG. 17, the first optical device 35 further includes a prism 353 and a first optical module 354. The prism 353 and the first optical module 354 are located between the image display element 351 and the optical transmission window 352. The first optical module 354 has the positive refractive power, and may be a single convex lens or a combination of multiple lenses. The light beam emitted by the image display element 351 reaches the first optical module 354 after undergoing at least one reflection in the prism 353, and then passes through the first optical module 354 to reach the optical transmission window 352.

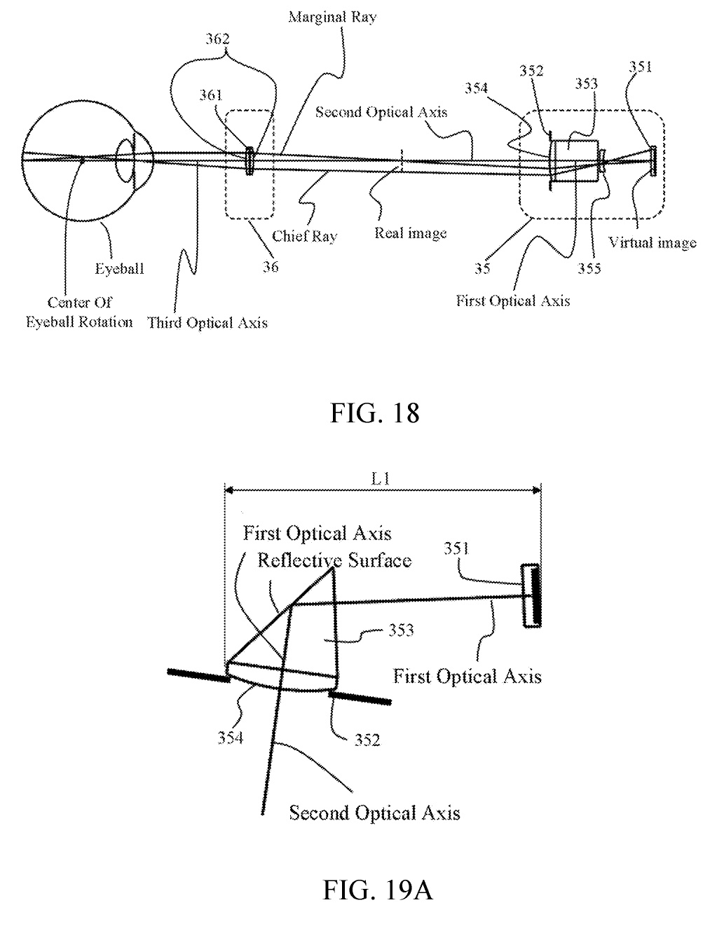

Optionally, as shown in FIG. 18, a lens with negative refractive power 355 may further be provided between the image display element 351 and the prism 353. It should be noted that the lens with negative refractive power 355 is illustrated as a plano-concave lens in FIG. 9, the concave surface of the lens with negative refractive power 355 faces the image display element 351, and the flat surface of the lens with negative refractive power 355 faces the prism 353. However, other types of lenses with negative refractive power may also be adopted in specific implementation.

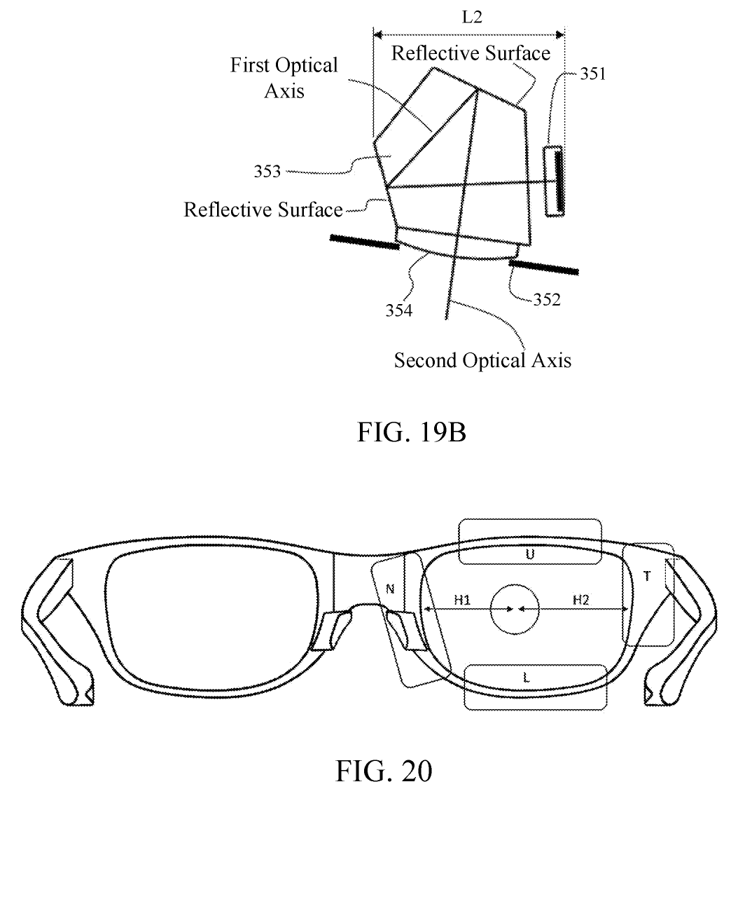

It should be noted that the size of the prism 353 in FIGS. 17 and 18 can be flexibly designed. As shown in FIG. 19A, the prism 353 has only one reflective surface, and the light beam emitted by the image display element 351 reaches the first optical module 354 after undergoing one reflection in the prism 353. The design shown in FIG. 19A requires the first optical device 35 to have a longer dimension L1. Correspondingly, as shown in FIG. 19B, the prism 353 has two reflective surfaces, and the light beam emitted by the image display element 351 reaches the first optical module 354 after undergoing two reflections in the prism 353. The design shown in FIG. 19B requires the first optical device 35 to have a shorter dimension L2. Accordingly, when the first optical device 35 needs to be extremely small in size, this can be achieved by increasing the number of reflective surfaces in the prism 353.

The following details the design principles of the smart glasses provided by the present disclosure and the advantages of such a design. Referring to FIG. 20, the inner side of the frame is divided into four areas: U (upper rim of the frame), L (lower rim of the frame), T (temple side), and N (nose pad side), and the advantages and challenges of each area are summarized. To simplify the explanation, it is assumed in FIG. 20 that the optical engine is placed on the right side of the right frame, and the images are displayed in the wearer's right eye. It will be understood by those skilled in the art that even if the left and right sides are swapped, that is, the optical engine is on the left side of the left frame and the images are displayed in the wearer's left eye, this explanation remains valid and the principle is the same.

For area U: the area U has the same problem as the third type of near-eye display technology described in the background art.

For area L: the second optical device 36 will block the most important external field of view in daily life. When performing detailed tasks at close range, the wearer usually looks down and completes the work by using both eyes to perceive height. However, if the second optical device 36 is placed in the area L, it will block the lower field of view of the right eye, thereby impairing binocular vision, making manual operations more difficult, and causing great inconvenience to the wearer.

Furthermore, the typical eyeglass frame designs have the lower part of the frame designed to be relatively thin for aesthetic purposes. If this design is adopted, the frame cannot fully conceal the second optical device 36.

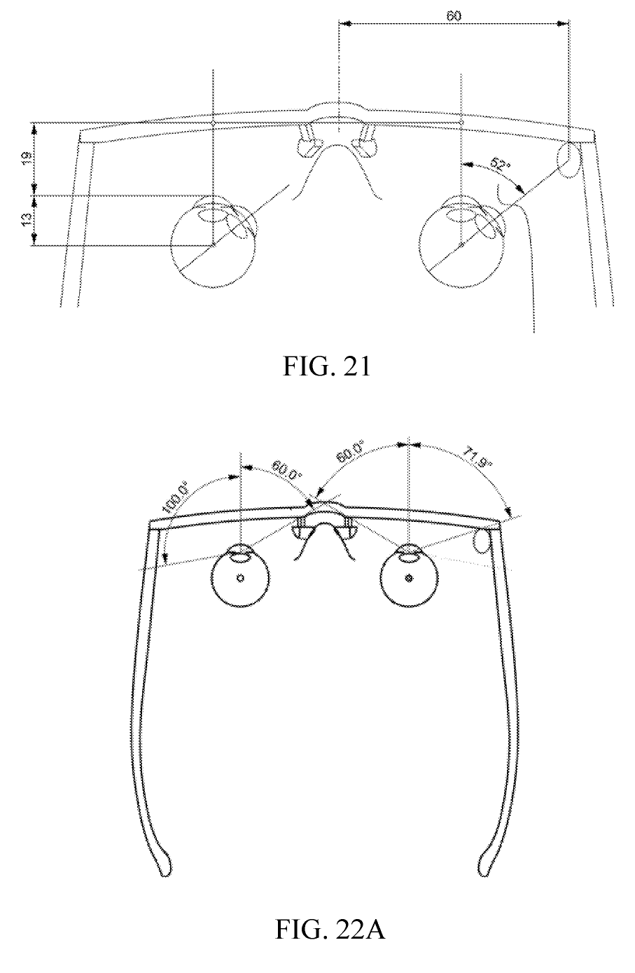

For area T: as shown in FIG. 20, the design of standard eyeglasses places the wearer's pupils at a position near the nose side of the frame's center. According to this design, placing the second optical device 36 in the area T will result in the line-of-sight angle exceeding 40 degrees (as shown in FIG. 21). Once the line-of-sight angle exceeds 40 degrees, maintaining viewing at that angle will be extremely difficult for the user.

For area N: as shown in FIG. 20, the design of standard eyeglasses places the wearer's pupils at the position near the nose side of the frame's center. Following this design, even when the second optical device 36 is placed in the area N, the line-of-sight angle can still be kept within 40 degrees, thus presenting images in a position easy to view. Furthermore, although the user needs to engage in side viewing to see the images, this does not appear odd to third parties, as side viewing is a frequent and familiar action in daily life.

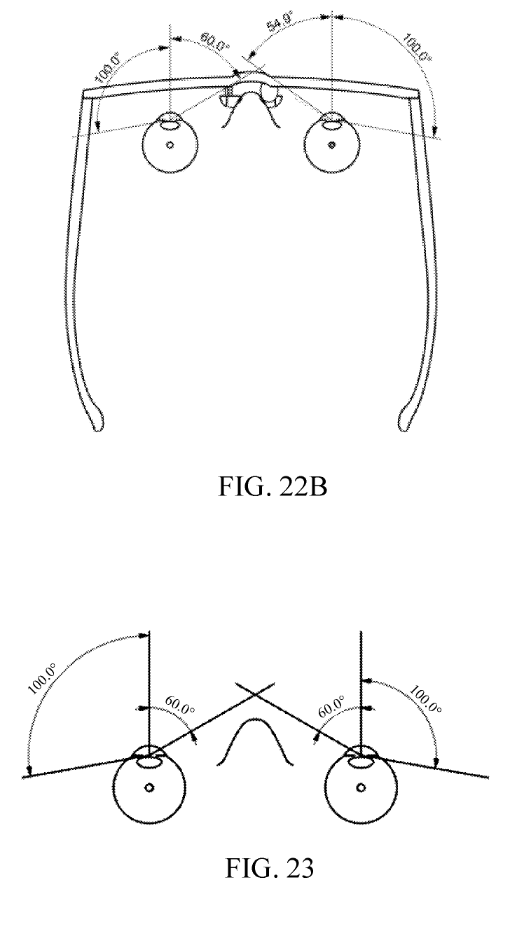

With this arrangement, the second optical device 36 may block the left edge of the right eye's field of view, but its negative impact is very small. FIGS. 22A and 22B show a comparison of line-of-sight obstruction when the second optical device 36 is located in the area T and the area N, respectively. As shown in FIG. 23, the people use both eyes in daily life, and the left field of view is processed solely by the left eye. Therefore, even if the second optical device 36 blocks the left edge of the right eye's field of view, it will not reduce the overall binocular field of view and will hardly interfere with daily activities.

Furthermore, if the second optical device 36 is placed in the area N, not only can the device be concealed via the frame, but the nose bridge area can also be used for shielding, thereby making it possible to place a larger second optical device 36 without being noticeable.

Conclusion: it can thus be seen that the second optical device 36 as the ocular optical device cannot be simply placed at any position on the back of the frame. As pointed out in the present disclosure, the most optimal placement position is the area N, that is, near the nose pad and on the side of the frame close to the face.

As described above, the key design point of the present disclosure lies in that the smart glasses include: the "first optical device" located on the side of the frame close to the face and adjacent to the temple, and the "second optical device (ocular optical device)" located on the side of the frame close to the face and adjacent to the nose pad. The second optical device 36 does not integrate a display element, thus allowing the size of the second optical device 36 to be reduced. Meanwhile, as there is no need for internal wiring within the frame, a higher level of aesthetic design can be achieved.

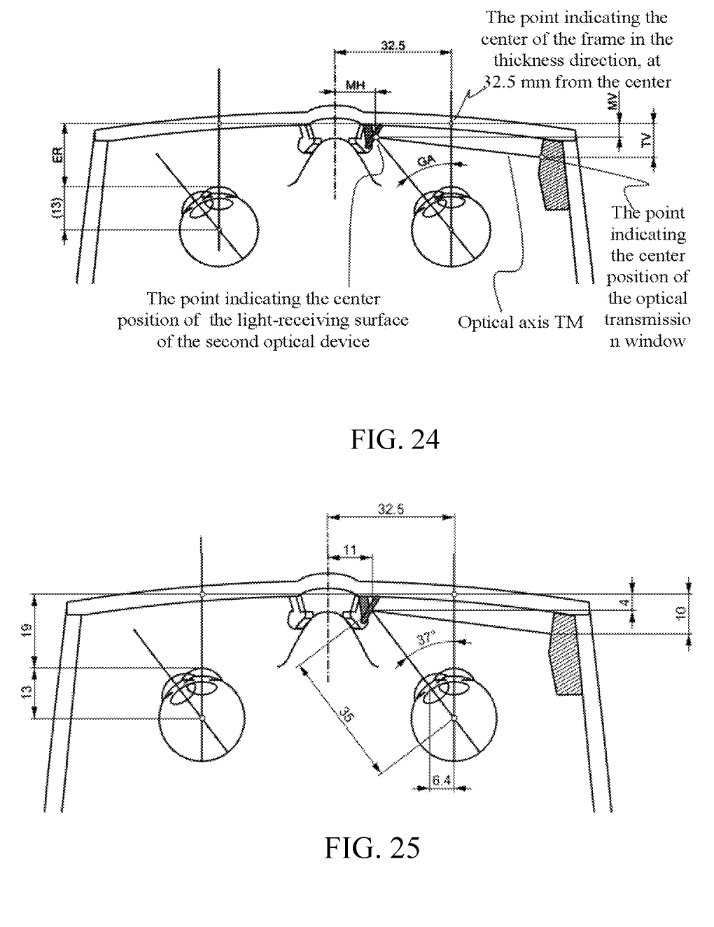

The positions of the first optical device 35 and the second optical device 36 are as shown in FIG. 24. As a preferred design, they should meet the following angle and length requirements:

GA (Line-of-Sight Angle): ≤ 40 degrees; if it exceeds 40 degrees, the burden of maintaining the line of sight will be significant.

MH (Horizontal Distance): ≤ 15 mm; if it exceeds 15 mm, the second optical device 36 will appear prominent from a third party's perspective.

MV (Vertical Distance): ≤ 12 mm; since the optical axis TM is close to the face, the lights from the first optical device 35 to the second optical device 36 are more susceptible to interference from the upper eyelid.

TV (Vertical Distance): ≤ 20 mm; since the optical axis TM is close to the face, the lights from the first optical device 35 to the second optical device 36 are susceptible to interference from the upper eyelid.

FIG. 25 further shows specific values as examples.

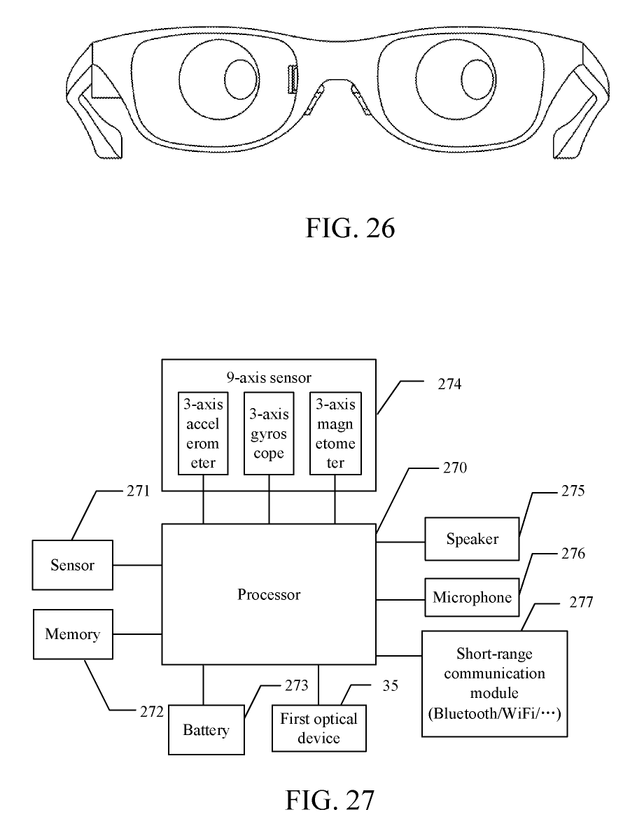

Furthermore, FIG. 26 shows the appearance of the glasses in FIG. 25 as viewed from a third party's front perspective. It can be confirmed from FIG. 26 that since the optical devices are shielded by the frame and the nose bridge, they are not noticeable to third party. In other embodiments of the present disclosure, the smart glasses may have two first optical devices (A1, A2) and their corresponding orientation adjustment devices, and two second optical devices (B1, B2) and their corresponding orientation adjustment devices, which are configured to project the images onto the left and right eyes of the wearer respectively. The two first optical devices (A1, A2) and their corresponding orientation adjustment devices are identical or similar in structure and symmetrically mounted, and the same applies to the two second optical devices (B1, B2) and their corresponding orientation adjustment devices.

Based on the structure of the smart glasses described above, the smart glasses provided by the present disclosure may further include an eyeball-tracking function. When it is determined that the wearer's eyes are looking toward the second optical device 36, the first optical device 35 is then controlled to emit the light beam. When the wearer's eyes are not looking toward the second optical device 36, the first optical device 35 does not emit the light beam. In this way, the power consumption of the first optical device 35 can be saved. As shown in FIG. 27, the smart glasses are equipped with a built-in processor 270, a sensor 271, a memory 272, and a battery 273. It should be noted that for ease of understanding, only one of each component is shown in the FIG. 27, and it is not limited to this in practical applications. For example, according to specific requirements, two or more processors, sensors, speakers, and so on may be configured in the smart glasses. The sensor 271 is used to track and capture the movement trajectory of the wearer's eyeballs in real time, which can be achieved using CCD sensors, CMOS sensors, infrared sensors, and the like. The sensor 271 may be placed near the inner side of the temple 33 and close to the first optical device 35, or placed near the nose pad and close to the second optical device 36, or placed on the inner side of upper rim of the frame. The inner side of upper rim of the frame is the preferred position. The processor 270, the memory 272, and the battery 273 may be built into the frame 31 or the temple(s) 33.

The battery 273 is connected to the processor 270, the sensor 271 and the first optical device 35, and is used to supply power to the processor 270, the sensor 271, and the first optical device 35. Furthermore, the smart glasses may further include: a 9-axis sensor 274, at least one speaker 275, at least one microphone 276, and a short-range communication module 277, which are connected to the processor 270.

The 9-axis sensor is used to detect postures or movements of the wearer. The at least one speaker 275 is used to output audio signals. The at least one microphone 276 is used to pick up voice signals of the user.

The short-range communication module 277 may include a Bluetooth module, or a Bluetooth module and a WiFi module, and is used to transfer wireless signals. The transfer of signals refers to wirelessly transmitting, via Bluetooth or WiFi, data from the smart glasses to external smart devices (such as smart phones), for algorithmic processing and analysis. Of course, if the smart glasses themselves do not need to undertake complex data processing functions, the processor 270 may further reuse the short-range communication module 277, and when the processor 270 reuses the short-range communication module 277, the short-range communication module 277 further acts as the main control component of the smart glasses, for example, controlling wireless communication protocols, microphone input, speaker output, and the like.

The memory 272 stores program instructions executable by the processor 270. The program instructions are used to: analyze the images of the eyeball of the user sensed by the sensor 271, and determine whether the eyeball state of the user meets a preset light emission trigger condition; and control the first optical device 35 to emit the light beam in response to the eyeball state of the user meeting the preset light emission trigger condition.

Specifically, as an optional solution, the sensor 271 may include an infrared LED and a camera. The infrared LED is used to emit infrared light toward at least one of the eyes of the wearer. The camera is used to track and capture the movement trajectory of the wearer's eyeball. The infrared light forms bright spots on the eyeball, and the camera is used to continuously track and capture the positions of the formed bright spots, thereby determining the movement direction of the eyeball. The program instructions are further used to: control the first optical device 35 to emit the light beam in response to determining that the eyeball of the user is looking toward the second optical device 36. In this solution, the smart glasses are equipped with the eyeball-tracking function. The first optical device 35 is controlled to emit the light beam only when the eyeball of the wearer looks at the second optical device 36, while the first optical device 35 does not emit the light beam when the eyeball of the wearer does not look at the second optical device 36. Thus, the power consumption of the first optical device 35 can be reduced.

Specifically, as an optional solution, the sensor 271 captures eyeball images of the wearer in real time, and the program instructions are further used to: control the first optical device 35 to emit the light beam in response to the eyeball state of the user meeting a preset fatigue state. This solution can be used to analyze and determine whether the wearer is in scenarios of fatigued driving or dozing off during study or work. For example, the frequency of eye closures for the wearer is analyzed to determine whether the wearer is fatigued or dozing off. When no eyeballs are identified from the eyeball images, it indicates that the eyes are closed. When the eyeballs are identified from the eyeball images, it indicates that the eyes are open. By analyzing multiple consecutive frames of images, the frequency of eye closures for the wearer can be determined. When the frequency of eye closures exceeds the preset frequency threshold, it indicates that the eyes of the wearer are closed for an extended period, and the wearer is in a fatigued state or a dozing state. For another example, a pre-trained eyeball state detection model is stored in the memory 272. The program instructions are further used to: input the captured eyeball images into the eyeball state detection model, and determine the current state of the wearer through the training and analysis of the eyeball state detection model. When it is determined that the current state of the wearer is a fatigued state, the first optical device 35 is controlled to emit the light beam.

Furthermore, the eyeball state detection model may classify the current state of the wearer into different levels of fatigue according to the detected fatigue level. For different levels of fatigue, the first optical device 35 may be controlled to emit the light beam in different ways. For example, when the wearer is in a state of mild fatigue, the first optical device 35 is controlled to emit a light beam with normal brightness; when the wearer is in a state of moderate fatigue, the first optical device 35 is controlled to emit a very bright light beam; and when the wearer is in a state of severe fatigue, the first optical device 35 is controlled to emit a light beam that flickers on and off rapidly.

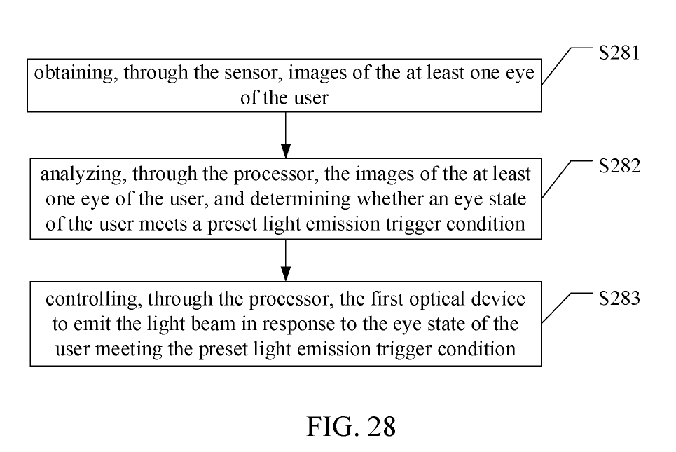

Referring to FIG. 28, a flow chart of a control method for the smart glasses shown in FIGS. 3-27. As shown in FIG. 28, the control method comprises:

step S281, obtaining, through the sensor, images of the at least one eye of the user;

step S282, analyzing, through the processor, the images of the at least one eye of the user, and determining whether an eye state of the user meets a preset light emission trigger condition; and

step S283, controlling, through the processor, the first optical device to emit the light beam in response to the eye state of the user meeting the preset light emission trigger condition.

Alternatively, in an embodiment of the present disclosure, the step of controlling, through the processor, the first optical device to emit the light beam in response to the eye state of the user meeting the preset light emission trigger condition comprises: controlling, through the processor, the first optical device to emit the light beam in response to determining that the at least one eye of the user is looking toward the second optical device.

Alternatively, in an embodiment of the present disclosure, the step of controlling, through the processor, the first optical device to emit the light beam in response to the eye state of the user meeting the preset light emission trigger condition comprises: controlling, through the processor, the first optical device to emit the light beam in response to the eye state of the user meeting a preset fatigue state.

For the details not elaborated above regarding the control method, reference may also be made to the aforementioned embodiments regarding the smart glasses shown in FIGS. 3-27, and details are not repeated here.

The foregoing are only some embodiments of the present disclosure, and are not intended to limit thereto. For those skilled in the art, the present disclosure may have various modifications and variations. Any modifications, equivalent replacements, improvements, and the like made within the spirit and principles of the present disclosure should be included within the scope of the present disclosure.

What is claimed is:

1. Smart glasses with display, comprising a frame, lenses and a temple, wherein a nose pad is provided on rims of the frame; and
wherein the smart glasses further comprise:
a first optical device, provided on an inner side of the smart glasses, and configured to emit a light beam carrying image information; and
a second optical device, located on the nose pad or a rim nearby a nose pad location, wherein the second optical device directly faces a light-emitting surface of the first optical device, and is configured to guide the light beam toward an eye of a user.

2. The smart glasses of claim 1, wherein both sides of the frame bend towards the temples of the smart glasses to form end-pieces;
the end-pieces are connected to the temples of the smart glasses; and
the inner side is an inner side of one of the end-pieces.

3. The smart glasses of claim 1, wherein the inner side is an inner side of an end of the temple close to the frame.

4. The smart glasses of claim 1, wherein the smart glasses further comprise a first orientation adjustment device; and
the first orientation adjustment device is provided on the temple and connected to the first optical device, and is configured to adjust a position of the first optical device on the temple and/or a light-emitting direction of the first optical device.

5. The smart glasses of claim 1, wherein the second optical device is located on the rim nearby the nose pad location, and the second optical device is located below the nose pad.

6. The smart glasses of claim 1, wherein the second optical device is integrally formed on a surface of the nose pad or on a surface of the rim nearby the nose pad location, and the surface faces a light-emitting direction of the first optical device.

7. The smart glasses of claim 1, wherein the second optical device is removably mounted on a surface of the nose pad or on a surface of the rim nearby the nose pad location, and the surface faces a light-emitting direction of the first optical device.

8. The smart glasses of claim 1, wherein the second optical device is fixedly mounted on a surface of the nose pad or on a surface of the rim nearby the nose pad location, and the surface faces a light-emitting direction of the first optical device.

9. The smart glasses of claim 6, wherein the smart glasses further comprise a second orientation adjustment device; and
the second orientation adjustment device is provided on the frame and connected to the second optical device or to the nose pad on which the second optical device is mounted, and is configured to adjust an inclination angle of the second optical device so that an angle between the second optical device and the eye of the user changes relative to the first optical device.

10. The smart glasses of claim 1, wherein the second optical device comprises a reflective surface, and a convex surface is convexly provided on a light-incident side of the reflective surface; and
wherein the light beam passes through the convex surface and is incident on the reflective surface, the light beam is further reflected by the reflective surface and passes through the convex surface to the eye of the user, and a normal to the reflective surface has an inclination angle relative to an optical axis of the incident light beam.

11. The smart glasses of claim 1, wherein the second optical device comprises a concave mirror, the light beam is reflected by the concave mirror to the eye of the user, and a normal to the concave mirror has an inclination angle relative to an optical axis of the incident light beam.

12. The smart glasses of claim 1, wherein the first optical device comprises an image display element and an optical transmission window; and
the image display element is configured to emit the light beam carrying image information, and the light beam is emitted from the optical transmission window and is further transmitted toward a direction where the second optical device is located.

13. The smart glasses of claim 12, wherein a center position of the optical transmission window is lower than an upper surface of the temple.

14. The smart glasses of claim 12, wherein the first optical device further comprises: a prism and a first optical module, and the prism and the first optical module are provided between the image display element and the optical transmission window;
the first optical module has positive refractive power; and
the light beam emitted by the image display element reaches the first optical module after undergoing at least one reflection in the prism, and further passes through the first optical module to reach the optical transmission window.

15. The smart glasses of claim 14, wherein a lens with negative refractive power is provided between the image display element and the prism.

16. The smart glasses of claim 15, wherein the light beam emitted by the image display element reaches the first optical module after undergoing more than two reflections in the prism.

17. The smart glasses of claim 1, wherein the inner side of the smart glasses is provided with a sensor, and a battery, a memory and a processor are built in the frame or the temple;
the battery is connected to the sensor, the processor and the first optical device, and is configured to supply power to the sensor, the processor and the first optical device;
the sensor is configured to sense images of eyeballs of the user; and
the memory stores program instructions executable by the processor, and the program instructions are configured to:
analyze the images of the eyeballs of the user sensed by the sensor, and determine whether an eyeball state of the user meets a preset light emission trigger condition; and
control the first optical device to emit the light beam in response to the eyeball state of the user meeting the preset light emission trigger condition.

18. The smart glasses of claim 17, wherein the program instructions are further configured to:
control the first optical device to emit the light beam in response to determining that the eyeballs of the user are looking toward the second optical device.

19. The smart glasses of claim 17, wherein the program instructions are further configured to:
control the first optical device to emit the light beam in response to the eyeball state of the user meeting a preset fatigue state.

20. A control method for the smart glasses of claim 1, wherein the smart glasses further comprise a sensor and a processor, and the control method comprises:
obtaining, through the sensor, images of the at least one eye of the user;
analyzing, through the processor, the images of the at least one eye of the user, and determining whether an eye state of the user meets a preset light emission trigger condition; and
controlling, through the processor, the first optical device to emit the light beam in response to the eye state of the user meeting the preset light emission trigger condition.
